(19) United States
(12) Patent Application Publication
(10) Pub. No.: US 2008/0075473 A1
(43) Pub. Date: Mar. 27, 2008

(54) Receiver circuit

(75) Inventor: Koichi Iguchi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/902,916

(22) Filed: Sep. 26, 2007

(30) Foreign Application Priority Data
Sep. 27, 2006 (JP) 2006-262645

(51) Int. Cl. H04B 10/06

(52) U.S. Cl. 398/202

(57) ABSTRACT

A receiver circuit includes a photodiode, a first amplifier to convert a current of the photodiode into a voltage, a second amplifier to adjust an offset voltage of the first amplifier and a control unit to control on/off of an offset voltage adjustment function of the second amplifier. The control unit turns off the offset voltage adjustment function of the second amplifier in a predetermined period after power on.

### BACKGROUND OF THE INVENTION

1. Field of the Invention

The present invention relates to a receiver circuit for receiving a light signal, and particularly to a receiver circuit for outputting an electric signal corresponding to a light signal received by a photodiode.

2. Description of Related Art

An optical pickup is a device which reads and writes data from/to an optical disc, such as CD and DVD. In the optical pickup, a receiver circuit is mounted, which is equipped with functions to receive a catoptric light from an optical disc to a photodiode as a light signal so as to amplify and output a current signal generated from the light signal. The characteristics required in the abovementioned receiver circuit is to be able to convert a photoelectric current signal generated by a photodiode into a voltage signal in wideband from 0 MHz (a direct current) to several 100 MHz, to control the error of the converted voltage to be ten and several mV or less for example, and to avoid malfunction in the next stage circuit which inputs an output signal of the receiver circuit by outputting a signal stabilized from immediately after power on.

Hereafter, a receiver circuit of a related art is explained with reference to FIGS. 2 and 7. The receiver circuit of the related art includes a photodiode PD, an amplifier A1 and a feedback resister “r”, as shown in FIG. 7.

An anode of the photodiode PD is connected to ground and a cathode of the photodiode PD is connected to an inverting input terminal of the amplifier A1 and an end of the feedback resister “r”. The other end of the feedback resister “r” is connected to an output terminal of the amplifier A1. The noninverting input terminal of the amplifier A1 is connected to a reference voltage Vc.

Next, the structure of an internal circuit of the amplifier A1 is explained. Inside of the amplifier A1 is formed of a differential amplifier circuit “a” and a buffer “b”, as shown in FIG. 2. The differential amplifier circuit “a” includes two N-channel MOSFETs (MN1 and MN2) forming a differential pair, two P-channel MOSFETs (MP1 and MP2) forming an active load which is provided between the differential pair and a power supply potential VCC, and a current source CS1 provided between the differential pair and a ground potential GND.

Then, the operation in the receiver circuit of the related art is explained. The receiver circuit of the related art shown in FIG. 7 converts a current Ip of the photodiode PD into a voltage by the feedback resister “r” using an amplification operation of the amplifier A1 and a negative feedback operation in the whole receiver circuit through the feedback resister “r”. At this time, assuming that a reference voltage supplied to the noninverting input terminal of the amplifier A1 is Vc, an output voltage Vout of the amplifier A1 can be expressed as follows.

Vout=Ip×r+Vc+ΔV1

Here, ΔV1 is a voltage variation (hereafter also referred to as an input offset voltage variation) caused by variations such as in the transconductance gm and threshold voltage VT of the N-channel amplification MOSFETs (MN1 and MN2) and the P-channel load MOSFETs (MP1 and MP2) of the input unit of the differential amplifier circuit “a” in the amplifier A1 shown in FIG. 2.

Although the output voltage Vout for this receiver circuit of the related art is expressed as Vout=Ip×r+Vc+ΔV1, in order to reduce the offset voltage variation ΔV1, it is necessary to increase either or both of the gate length and the gate width of a MOSFET used for the differential amplifier circuit “a” of the amplifier A1 shown in FIG. 2. The relation between the threshold voltage variation of MOSFETs and a gate area L×W of a MOSFET is shown in FIG. 3. Note that L is gate length and W is gate width.

As can be seen in FIG. 3, the variation a of the threshold voltage VT reduces as the gate area increases. Likewise for the MOSFETs (MN1, MN2, MP1 and MP2) of the differential amplifier circuit “a” shown in FIG. 2 used for the receiver circuit, the variation of the threshold voltage VT is dependent on the gate area. Thus when either or both of the gate length L and the gate width W is reduced for the MN1, MN2, MP1 and MP2, the threshold voltage variation increases and when either or both of the gate length L and the gate width W is increased for the MN1, MN2, MP1 and MP2, the threshold voltage variation reduces.

On the other hand, by increasing either or both of the gate length L and the gate width W, the open loop characteristics (open loop gain, cut-off frequency and phase characteristic, etc.) of the differential amplifier circuit “a” inside the amplifier A1 deteriorate and the wideband characteristic of a current-voltage conversion circuit using the feedback resister “r” also deteriorate.

Therefore, in the receiver circuit of the related art shown in FIG. 7, as a current-voltage conversion circuit is formed from one amplifier, from the trade-off with the amplifier frequency characteristic and the size dependency of variations such as in the transconductance gm and the threshold voltage VT of MOSFETs, both the “wideband characteristic” and the “low offset voltage variation” of the amplifier A1 are hard to realize, and as a result, it is difficult to achieve both characteristics of the “wideband characteristic” and the “low offset voltage variation” as a receiver circuit for converting a photodiode current into a voltage.

On the other hand, a receiver circuit disclosed in Japanese Unexamined Patent Application Publication No. 2002-176324 has both characteristics of the “wideband characteristic” and the “low offset voltage variation.” This receiver circuit is explained with reference to FIGS. 8 and 9.

This receiver circuit includes a photodiode PD, an amplifier OP1, an amplifier OP2, a FET2 and feedback resisters R1 and R2 as shown in FIG. 8.

An anode of the photodiode PD is connected to 0 V and a cathode of the photodiode PD is connected to one end of the feedback resister R1, one end of the feedback resister R2 and a gate G of the FET2. Another end of the feedback resister R1 is connected to an output terminal of the amplifier OP1 and another end of the feedback resister R2 is connected to an inverting input terminal of the amplifier OP2, respectively. A drain D of the FET2 is connected to +5V and a source S of the FET2 is connected to −5V and an inverting input terminal of the amplifier OP1, respectively. A noninverting input terminal of the amplifier OP2 is connected to 0V and an output terminal of the amplifier OP2 is connected to a noninverting input terminal of the amplifier OP1, respectively.

As with the receiver circuit of the related art shown in FIG. 7, by the amplifier OP1 for current-voltage conversion and the feedback resister R1, this receiver circuit converts a current Ipd of the photodiode PD into a voltage Ipd×R1. In addition, this receiver circuit has the amplifier OP2. An output voltage Vout can be expressed as follows.

Vout=Ipd+ΔV3−5V

Here, ΔV2 and ΔV3 shown in FIG. 8 are the input offset voltage variations of the amplifiers OP1 and OP2 respectively.

In the receiver circuit shown in FIG. 8, although the input offset voltage variations ΔV2 and ΔV3 are generated respectively in the amplifiers OP1 and OP2, by a differential amplifier operation of the amplifiers OP1 and OP2 and a negative feedback operation as the whole receiver circuit, only the input offset voltage variation ΔV3 of the amplifier OP2 has an effect on the output voltage Vout. On the other hand, the input offset voltage variation ΔV2 of the amplifier OP1 has no effect on the output voltage Vout due to the correction effect by the addition of the amplifier OP2.

As mentioned above, it is usually difficult to achieve both the low offset voltage variation and the wide frequency band characteristic with one amplifier due to the relation of trade-off in the input offset voltage and wideband operation of the amplifier. In the receiver circuit of the related art shown in FIG. 8, by using a wideband amplifier for the amplifier OP1 and an amplifier of low input offset voltage variation for the amplifier OP2, it is possible to realize a current-voltage conversion circuit with wideband and small offset voltage variation. However, in the receiver circuit of the related art shown in FIG. 8, after power on, until an output voltage of the amplifier OP2 converges to the stable value defined in the following formula, which is;

Vout=Ipd+ΔV3−5V

The output Vout largely fluctuates. Therefore, malfunction may occur in the next stage circuit which inputs an output signal of the receiver circuit after power on.

Moreover, as another example of achieving both the “wideband characteristic” and the “low offset voltage variation”, there is a receiver circuit disclosed in Japanese Unexamined Patent Application Publication No. 2004-153012. This receiver circuit is explained with reference to FIG. 10.

This receiver circuit includes a photodiode 11, a diode 12, a feedback resister 13, a feedback resister 14, a capacitor 15, an amplifier 21 and an amplifier 22 as shown in FIG. 10.

A cathode of the photodiode 11 is connected to a voltage source V+. An anode of the photodiode 11 is connected to one end of the feedback resister 13, one end of the feedback resister 14, an anode of the diode 12 and an inverting input terminal of the amplifier 22. The other end of the feedback resister 13 is connected to one end of the capacitor 15 and an inverting input terminal of amplifier 21. The other end of the feedback resister 14 is connected to a cathode of the diode 12 and an output terminal of the amplifier 22. The other end of the capacitor 15 is connected to an output terminal of the amplifier 21 and a noninverting input terminal of the amplifier 22. A noninverting input terminal of the amplifier 21 is connected to ground.

In addition, there is another related art disclosed in Japanese Unexamined Patent Application Publication No. 2005-294940.

In the receiver circuit disclosed in Japanese Unexamined Patent Application Publication No. 2002-176324 shown in FIG. 8, by using a wideband amplifier for the amplifier OP1 and an amplifier of low input offset voltage variation for the amplifier OP2, a current-voltage conversion circuit with wideband and small offset voltage value can be achieved. In this receiver circuit, a noninverting input voltage of the amplifier OP1 is determined by an inverting input voltage of the amplifier OP1. The inverting input voltage of the amplifier OP1 is determined by an output voltage of the amplifier OP1. The output voltage of the amplifier OP1 is determined by the noninverting input voltage and the inverting input voltage of the amplifier OP1. Moreover, the noninverting input voltage of the amplifier OP1, i.e., an output voltage of the amplifier OP2, is determined by an inverting input voltage of the amplifier OP2. Therefore, until the inverting input voltage and the output voltage of the amplifier OP2 are stabilized after power on, the output voltage Vout of the amplifier OP1, which is an output of the receiver circuit, fluctuates largely within the range from the minimum voltage VSS to the maximum voltage VCC of the amplifier OP1 as shown in FIG. 9.

Furthermore, also in the receiver circuit disclosed in Japanese Unexamined Patent Application Publication No. 2004-153012 shown in FIG. 10, in order to stabilize an input voltage V12 of the amplifier 22 for current-voltage conversion, it is required to stabilize a voltage V11 that is input into the inverting input terminal of the amplifier 21 through a resistance 13. Thus, until the inverting input voltage and the output voltage of the amplifier 21 are stabilized after power on, an output voltage V0 of the amplifier 22, which is an output of the receiver circuit, fluctuates largely.

Therefore, in the receiver circuit disclosed in Japanese Unexamined Patent Application Publications No. 2002-176324 and 2004-153012, as an output voltage largely fluctuates by the time an input voltage V of the amplifier for current-voltage conversion is stabilized, there is a problem that malfunction may occur in the next stage circuit.

### SUMMARY

In one embodiment, a receiver circuit includes a photodiode, a first amplifier to convert a current of the photodiode into a voltage, a second amplifier to adjust an offset voltage of the first amplifier and a control unit to control on/off of an offset voltage adjustment function of the second amplifier. The control unit turns off the offset voltage adjustment function of the second amplifier in a predetermined period after power on. In the present invention, by turning off the offset voltage adjustment function of the second amplifier for the predetermined period after power on, an output of the first amplifier can be an output of the receiver circuit.

The present invention is able to provide a receiver circuit capable of obtaining a stable output voltage.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a circuit diagram showing a receiver circuit according to a first embodiment of the present invention;

FIG. 2 is a circuit diagram showing an internal circuit of the amplifier of the receiver circuit;

FIG. 3 is a graph showing the size dependency of the threshold voltage variation of MOSFETs;

FIGS. 4A to 4D are graphs showing the frequency characteristic and pulse reply characteristic of receiver circuits according to a related art and the present invention;

FIGS. 5A and 5B are graphs showing an output voltage waveform of the receiver circuit according to the first embodiment of the present invention from after power on to stable operation;

FIG. 6 a circuit diagram showing the receiver circuit according to a second embodiment of the present invention;

FIG. 7 is a circuit diagram showing a receiver circuit according to a related art;

FIG. 8 is a circuit diagram showing a receiver circuit disclosed in Japanese Unexamined Patent Application Publication No. 2002-176324;

FIG. 9 is a graph showing an output voltage waveform of the receiver circuit disclosed in Japanese Unexamined Patent Application Publication No. 2002-176324 from after power on to stable operation; and

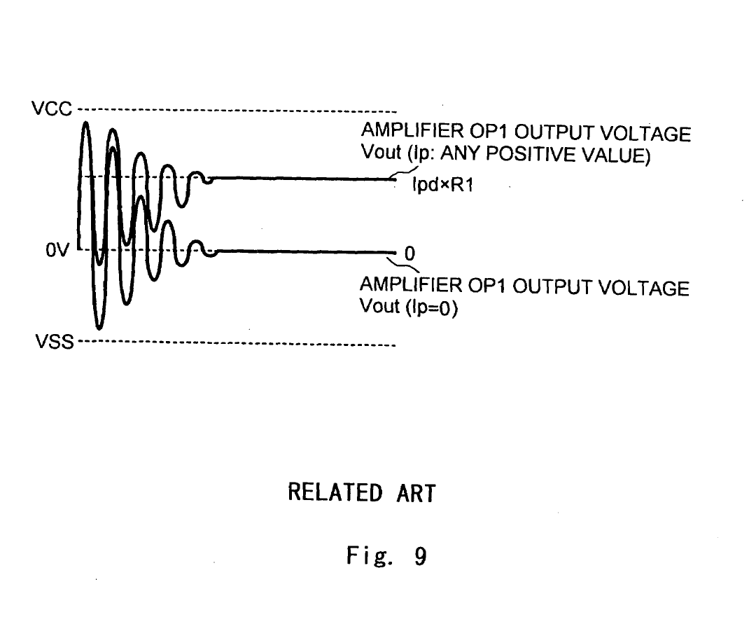

FIG. 10 is a circuit diagram showing a receiver circuit disclosed in Japanese Unexamined Patent Application Publication No. 2004-153012.

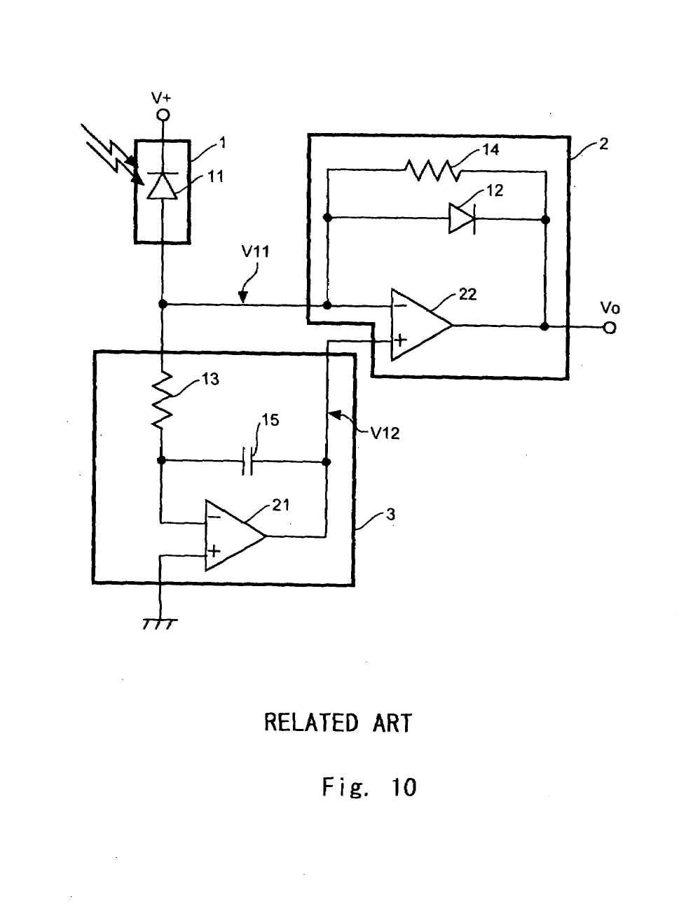

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

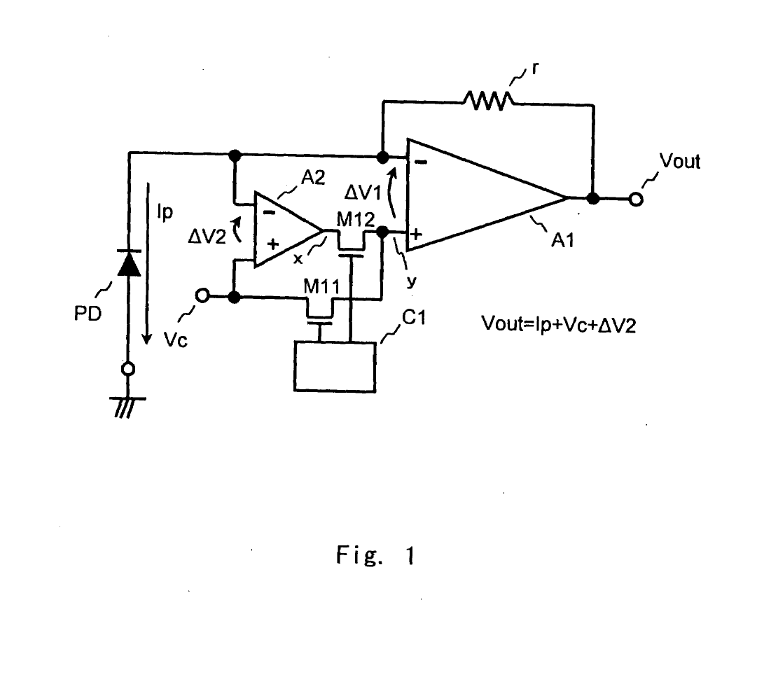

Firstly, the structure of a receiver circuit according to a first embodiment of the present invention is explained with reference to FIG. 1. As shown in FIG. 1, this receiver circuit includes a photodiode PD, an amplifier A1 for converting a current from the photodiode PD into a voltage, an amplifier A2 for adjusting an offset voltage of the amplifier A1 and a control unit for controlling on/off of an offset voltage adjustment function of the amplifier. The control unit includes a first MOSFET M1 connected between a noninverting input terminal of the amplifier A2 which is supplied with a reference voltage and a noninverting input terminal of the amplifier A1, a second MOSFET M12 connected between an output of the amplifier A2 and the noninverting input terminal of the amplifier A1, and a control circuit C1 for controlling on/off of the MOSFETs M11 and M12. Furthermore, a feedback resister “r” is provided in the amplifier A1.

The anode of the photodiode PD is connected to ground. The cathode of the photodiode PD is connected to the inverting input terminal of the amplifier A1, the inverting input terminal of the amplifier A2 and one end of the feedback resister “r”. The other end of the feedback resister “r” is connected to the output terminal of the amplifier A1. The MOSFET M11 is connected to the noninverting input terminal of the amplifier A1, the noninverting input terminal of the amplifier A2, a reference voltage Vc and the control circuit C1. The noninverting input terminal of the amplifier A2 is connected to the reference voltage Vc. The MOSFET M12 is connected to the noninverting input terminal of the amplifier A1, the output terminal of the amplifier A2 and the control circuit C1. In the following explanation, it is assumed that a voltage of the output terminal of the amplifier A2 is x and a voltage of the noninverting input terminal of the amplifier A1 is y.

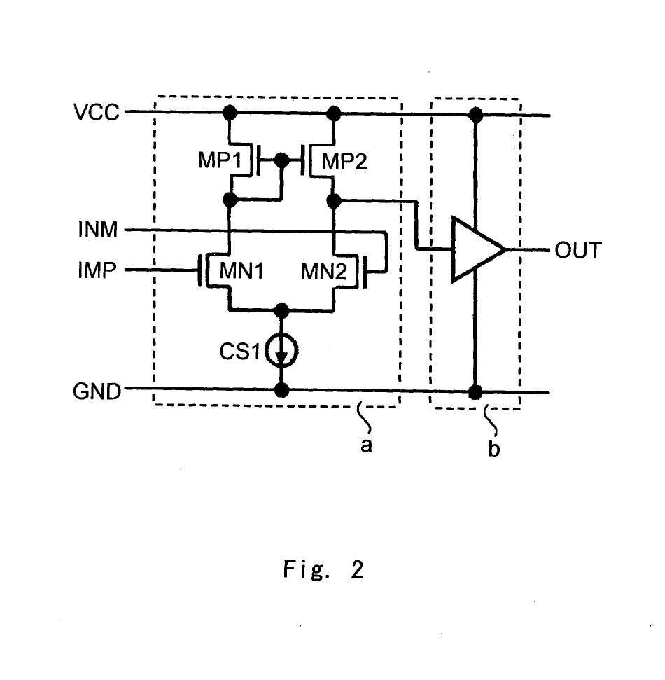

Next, the operation in the receiver circuit according to the first embodiment of the present invention is explained with reference to FIGS. 1 to 5. As shown in FIG. 1, the voltage Vc is supplied to the noninverting input terminal of the amplifier A2 as a reference voltage. Inside of the amplifier A2 is formed of a differential amplifier circuit “a” and a buffer b as shown in FIG. 2. The differential amplifier circuit “a” includes two N-channel MOSFETs (MN1 and MN2), forming a differential pair, two P-channel MOSFETs (MP1 and MP2), forming an active load provided between the differential pair and a power supply potential VCC and a current source CS1 provided between the differential pair and a ground potential GND. Since a gain to a differential input voltage of this differential amplifier circuit “a” is high, for example, 60 to 80 dB and an output of the amplifier A2 is stabilized at a limited voltage (near Vc), a voltage of the inverting input terminals of the amplifiers A1 and A2 will be Vc+ΔV2 when assuming that an input offset voltage variation of the amplifier A2 is ΔV2. Here, the input offset voltage variation ΔV2 is corresponding to the input offset voltage variation generated when the amplifier A2 is formed from a negative feedback circuit (voltage follower etc.) with one time gain.

Inside of the amplifier A1 is formed from the differential amplifier circuit “a” and the buffer “b” as shown in FIG. 2. The voltage variation ΔV1 corresponding to the input offset voltage generated when the amplifier A1 is formed from a negative feedback circuit (voltage follower etc.) with one time gain is generated between the input terminals of the amplifier A1. As mentioned above, since the voltage of the inverting input terminal of the amplifier A1 is Vc+ΔV2 by the operation of the amplifier A2, the noninverting input terminal of the amplifier A1 operates to be Vc+ΔV2−ΔV1 due to a voltage for the input offset voltage variation ΔV1 of the amplifier A1. Therefore, the offset voltage variation ΔV1 has no effect on the output voltage Vout. Thus, when a current of the photodiode PD is Ip, the output voltage Vout is the sum of the product of the photodiode current Ip and the feedback resister “r” and the voltage Vc+ΔV2 of the inverting input terminal of the amplifier A1, and is expressed as follows.

Vout=Ip×r+Vc+ΔV2

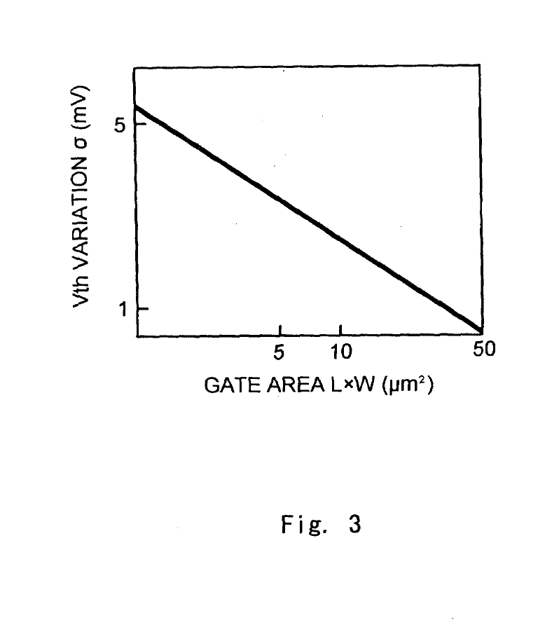

Inside of the amplifier A1, N-channel MOSFETs (MN1, MN2) and P-channel MOSFETs (MP1, MP2) with either or both of the gate length L and the gate width W being small is used for the differential amplifier circuit “a” as shown in FIG. 2. Accordingly, from the relation shown in the abovementioned FIG. 3, current-voltage conversion of the photodiode current Ip can be carried out in wideband from a direct current to several 100 MHz using the wideband characteristic of the differential amplifier circuit “a”.

Since the amplifier A2 does not need the wideband characteristic but requires the low offset voltage variation characteristic on the other hand, MOSFETs with either or both of the gate length L and the gate width W being larger than the MOSFETs used for the differential amplifier circuit of the amplifier A1 is used for the N-channel MOSFETs (MN1, MN2) and P-channel MOSFETs (MP1, MP2) of the differential amplifier circuit “a” as shown in FIG. 2. Accordingly, from the relation shown in the abovementioned FIG. 3, the differential amplifier circuit where the input offset voltage variation ΔV2 becomes the minimum can be used.

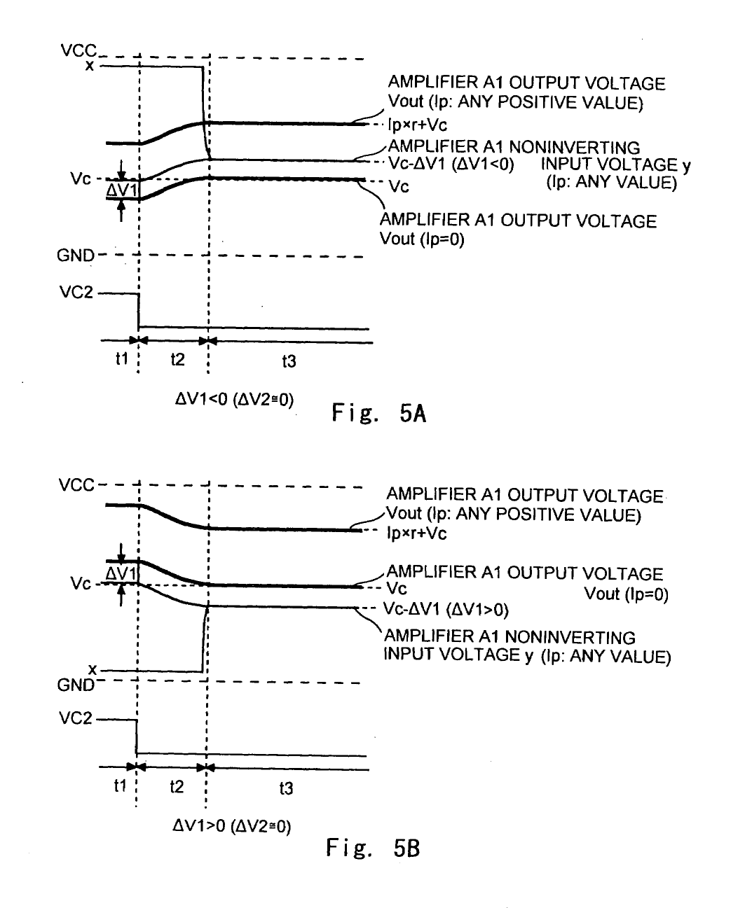

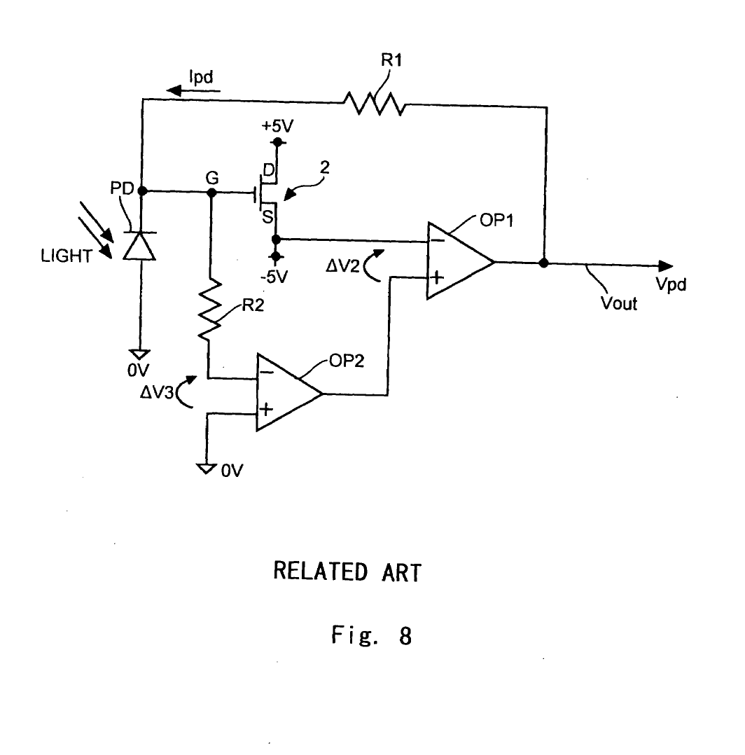

Moreover, in addition to the receiver circuit of the related art shown in FIG. 8, the receiver circuit shown in FIG. 1 has switching MOSFETs for controlling the voltage of the noninverting input terminal of the amplifier A1 so that the output voltage Vout is stabilized near Ip×r+Vc+ΔV2 in a short time after power on and the control circuit C1 for controlling the gate voltage of the switching MOSFETs so as to control the state. By the switching MOSFETs (M11 and M12) and the control circuit C1, on/off of the offset adjustment function of the amplifier A2 is controlled. To be more specific, as shown in FIGS. 5A and 5B, in the period t1 immediately after power on, by the control circuit C1, the MOSFET M11 is made to be on-state or low resistance state, the MOSFET M12 is made to be off-state or high resistance state and the noninverting terminal of the amplifier A1 is made to be Vc voltage. By this, the offset adjustment function of the amplifier A2 is turned off. At this time, the output voltage Vout of the amplifier A1 can be expressed as follows.

Vout=r×Ip+Vc+ΔV1

Here, ΔV1 is an input offset voltage variation of the amplifier A1. Next, by making the MOSFET M11 to be off or high resistance state by the C1 circuit, with the amplification operation of the amplifiers A1 and A2 and the negative feedback operation as the whole circuit, the noninverting terminal of the amplifier A1 changes from Vc to Vc+ΔV2−ΔV1 in a period t3 through the transition period of a period t2, as shown in FIGS. 5A and 5B. At this time, the output voltage Vout of the amplifier A1 can be expressed as follows.

Vout=r×Ip+Vc+ΔV2

In FIGS. 5A and 5B, it is simplified to voltage ΔV2≅0. As shown in FIGS. 5A and 5B, the feature of the receiver circuit of this example shown in FIG. 1 is that the noninverting terminal of the amplifier A1 changes from Vc to Vc+ΔV2−ΔV1 with a small voltage change ΔV2−ΔV1 after power on of the receiver circuit. Therefore, Vout becomes neither excessive (near power supply voltage VCC) nor too small (near GND). Therefore, malfunction of the next stage circuit which inputs the output voltage Vout of the receiver circuit can be prevented.

In addition, the period t2 in which the potential state of each terminal of the receiver circuit changes from the period t1 to the period t3 shown in FIGS. 5A and 5B is determined by a RC time constant. The CR time constant is determined by a resistance component of the switching MOSFET M12 in on-state or low resistance state and a gate capacitance of the noninverting terminal input unit MOSFET of the amplifier A1. Here, a resistance may be connected between MOSFET M12 and the noninverting terminal of the amplifier A1 in series. A capacitance may be connected between GND and the noninverting terminal of the amplifier A1 in series.

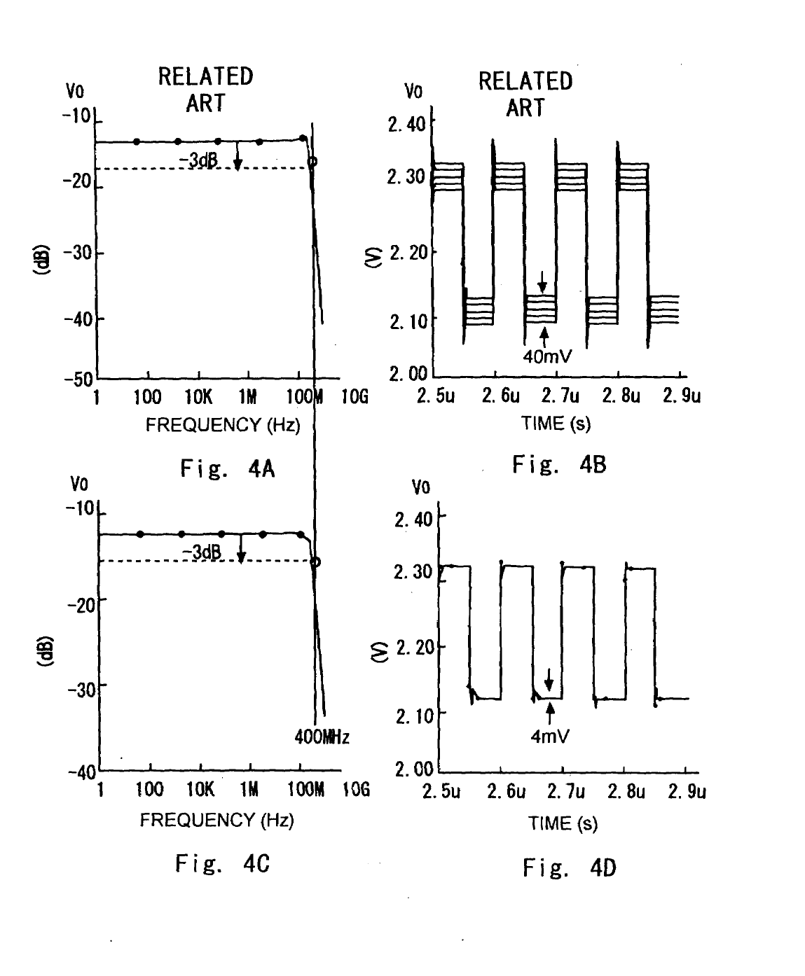

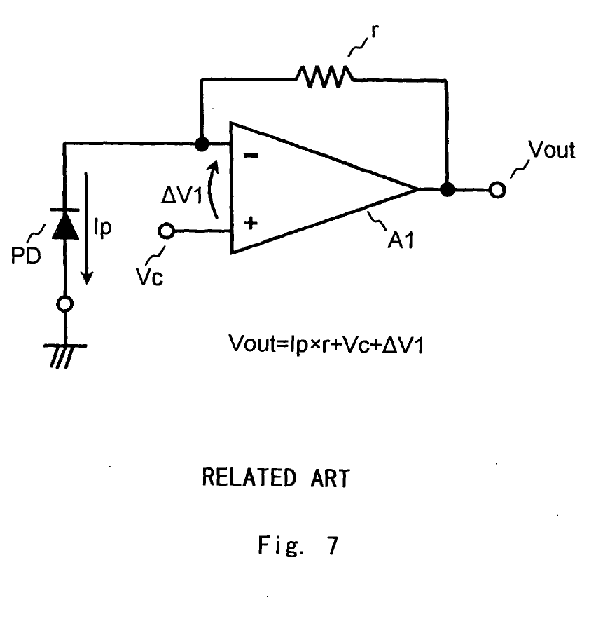

The frequency characteristic of the receiver circuit according to the related art illustrated in FIG. 7 is shown in FIG. 4A. Furthermore, FIG. 4B shows an output voltage waveform for a photodiode current input in pulse form in the receiver circuit according to the related art. Note that in FIGS. 4A and 4B, the input offset voltage variation ΔV1 of the amplifier A1 for current-voltage conversion shown in FIG. 7 is 40 mV.

The frequency characteristic of the receiver circuit according to the present invention is shown in FIG. 4C. Moreover, FIG. 4D shows an output voltage waveform for a photodiode current input in pulse form in the receiver circuit according to the present invention. Note that in FIGS. 4C and 4D, the input offset voltage variation ΔV1 of the current-voltage conversion amplifier A1 shown in FIG. 1 is 40 mV and the input offset voltage variation ΔV2 of the offset voltage adjustment amplifier A2 is 4 mV.

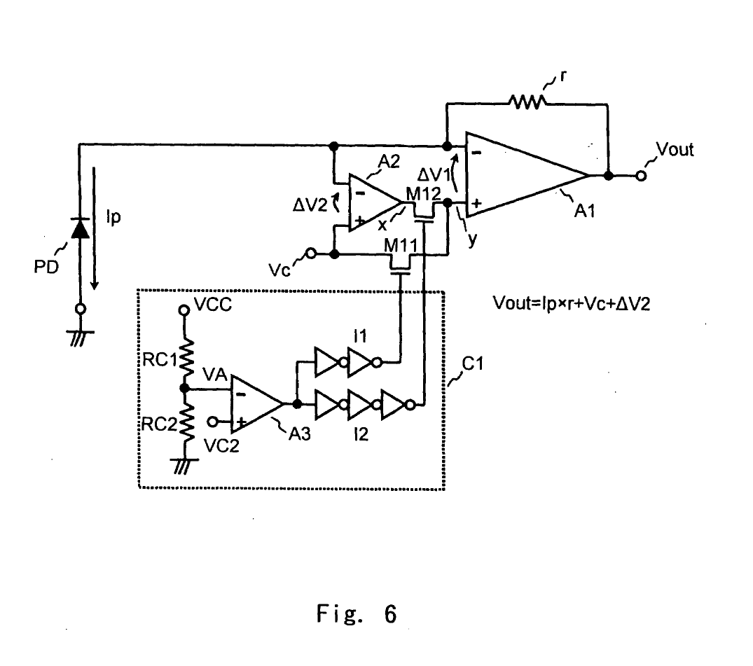

As shown in FIGS. 4A and 4C, in the receiver circuit according to the present invention, the frequency characteristic where the voltage value after current-voltage conversion is −3 dB is the same as that of the receiver circuit according to the related art. On the other hand, as shown in FIGS. 4B and 4D, the offset voltage variation of the output voltage is reduced to 4 mV, which is 1/10 of the related art. The offset voltage variation 4 mV is equivalent to the input offset voltage variation of the offset voltage adjustment amplifier A2 shown in FIGS. 1 and 6. As shown in FIGS. 4A to 4D, the receiver circuit according to the present invention has realized both characteristics of the wideband current-voltage conversion and the low offset voltage variation.

In this way, by using two amplifiers for the receiver circuit, where one amplifier is to be a circuit for current-voltage conversion in wideband and another amplifier is to be a circuit of low offset voltage variation for correcting an offset voltage variation in the current-voltage conversion circuit, it is possible to realize a receiver circuit with wideband and low offset voltage variation.

To be more specific, both characteristics of the “wideband characteristic” and the “low offset voltage variation” can be realized by applying the optimal size of MOSFETs for each of the wideband current-voltage conversion circuit and the offset voltage correction circuit.

Moreover, since the output voltage Vout only makes a small voltage change ΔV2−ΔV1 after power on of the receiver circuit, the output voltage Vout becomes neither excessive (near VCC) nor too little (near GND) even in the intermediate period until the correction operation for the voltage ΔV1 is stabilized. Thus, malfunction in the next stage circuit in a pickup device can be suppressed.

### Second Embodiment

Next, the structure of the receiver circuit according to a second embodiment is explained with reference to FIG. 6. Note that the structure of the receiver circuit according to the second embodiment of the present invention is that the control circuit C1 shown in FIG. 1 is illustrated specifically. Other components except the control circuit C1 are identical to the structure of the receiver circuit according to the first embodiment of the present invention and thus the explanation is omitted.

As shown in FIG. 6, the control circuit C1 includes a comparator A3, a resistance RC1, a resistance RC2, a 2-phase inverter I1 and a 3-phase inverter I2.

An inverting input terminal of the comparator A3 is connected to one end of the resistances RC1 and RC2. The other end of the resistance RC1 is connected to the power supply voltage VCC and the other end of the resistance RC2 is connected to ground, respectively. A noninverting input terminal of the comparator A3 is connected to a reference voltage VC2 and an output terminal of the comparator A3 is connected to input terminals of the 2-phase inverter I1 and the 3-phase inverter I2. An output terminal of the 2-phase inverter I1 is connected to a MOSFET M11 and an output terminal of the 3-phase inverter I2 is connected to a MOSFET M12, respectively.

Next, the operation in the receiver circuit according to the second embodiment of the present invention is explained. As shown in FIG. 6, the resistances RC1 and RC2 in the control circuit C1 divide the power supply voltage VCC and generate a voltage VA. The voltage VA is input into the inverting terminal of the comparator A3. A reference voltage VC generated inside an IC of the receiver circuit is input into the noninverting terminal of the comparator A3. The 2-phase inverter I1 and the 3-phase inverter I2 are connected to the output of the comparator A3. Thus, each output of the 2-phase inverter I1 and the 3-phase inverter I2 is input to each gate of the MOSFETs M11 and M12, respectively.

When the voltage VA input into the inverting input terminal of the comparator A3 is smaller than the reference voltage VC2, an output voltage of the comparator A3 becomes high-level, the MOSFET M11 is turned on and the MOSFET M12 is turned off. On the other hand, when the voltage VA is larger than the reference voltage VC2, the output voltage of the comparator A3 becomes low-level, the MOSFET M11 is turned off and the MOSFET M12 is turned on.

From the above operation, assuming that the period when the voltage VA shown in FIG. 6 is VA<VC2 is from the period t1 to t2 shown in FIGS. 5A and 5B and the period when VA is VA≧VC2 is the period t3 shown in FIGS. 5A and 5B, in the period from t1 to t2, the MOSFET M11 is on and the MOSFET M12 is off and in the period t3, the MOSFET M11 is off and the MOSFET M12 is on. Therefore, in the receiver circuit of this example shown in FIG. 6, as with the first embodiment, the offset adjustment function of the amplifier A2 is turned off in a predetermined period and turned on after the predetermined period. Thus, the receiver circuit according to this embodiment is able to supply the stable output voltage Vout to the next stage circuit.

It is apparent that the present invention is not limited to the above embodiments but it may be modified and changed without departing from the scope and spirit of the invention.

What is claimed is:

1. A receiver circuit comprising:
a photodiode;
a first amplifier to convert a current of the photodiode into a voltage;
a second amplifier to adjust an offset voltage of the first amplifier; and
a switching device connected between the first amplifier and the second amplifier.

2. The receiver circuit according to claim 1, wherein the receiver circuit further comprises:
a control circuit to control on/off of the switching device according to power supply potential.

3. A receiver circuit comprising:
a photodiode;
a first amplifier to convert a current of the photodiode into a voltage;
a second amplifier to adjust an offset voltage of the first amplifier; and
a control unit to control on/off of an offset voltage adjustment function of the second amplifier,
wherein the control unit turns off the offset voltage adjustment function of the second amplifier in a predetermined period after power on.

4. The receiver circuit according to claim 3, wherein the control unit comprises:
a first transistor connected between a noninverting input terminal of the second amplifier supplied with a reference voltage and a noninverting input terminal of the first amplifier;
a second transistor connected between an output terminal of the second amplifier and the noninverting input terminal of the first amplifier; and
a control circuit to control on/off of the first and the second transistors.

5. The receiver circuit according to claim 4, wherein the control circuit turns on the first transistor and turns off the second transistor at power on and after a predetermined period, the control circuit turns off the first transistor and turns on the second transistor.

6. The receiver circuit according to claim 3, wherein the first amplifier has a wider band characteristic than the second amplifier.

7. The receiver circuit according to claim 3, wherein the second amplifier has a smaller input offset voltage than the first amplifier.

8. The receiver circuit according to claim 3, wherein the first and the second amplifiers include a plurality of transistors and a gate length and/or a gate width of the transistors included in the first amplifier is smaller than a gate length and/or a gate width of the transistors included in the second amplifier.
